(19) United States
(12) Patent Application Publication
(10) Pub. No.: US 2001/0011583 A1
(43) Pub. Date: Aug. 9, 2001

(54) COMBINATION CARRIER AND HINGE FOR FOLDING PANELS

(76) Inventor: NIGEL FRANK SPORK, HENDRA (AU)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/389,723

(22) Filed: Sep. 3, 1999

(30) Foreign Application Priority Data
Sep. 4, 1998 (AU) PP5665

(51) Int. Cl. E05D 15/00

(52) U.S. Cl. 160/199; 16/105; 16/87 R

(57) ABSTRACT

A combination carrier and hinge assembly (10) for track-mounted adjacent panels comprises a butt hinge (11) having hinge leaves (14, 15) edge-fixed to adjacent panels (12, 12a). The hinge 11 also has a hinge pin (17) which extends above the hinge and is threaded into a carriage (13) which travels along a track (20). The fixing of the hinge leaves (14, 15) to the panels (12, 12a) is concealed when the panels are closed. A guide hinge (25) is provided at the bottom of the panels (12, 12a). The guide hinge (25) is a non-mortise butt hinge having leaves (26, 27) edge-fixed to the panels (12, 12a). The guide hinge (25) also has a hinge pin extending below the panels, and locating in a guide channel (23).

This invention relates to an improved carrier for suspending panels and the like, such as doors, windows, shutters and screens, from a track while permitting the panels to travel along the track and pivot about a vertical axis. In particular, the invention is directed to an improved combination carrier and hinge assembly for track-suspended panels (also referred to herein as track-mounted panels).

Throughout this specification and claims where the context permits, the term “panel” is intended to include components of folding doors, windows, shutters, screens and similar closures of a generally planar configuration suspended in an upright orientation. The invention will be described with particular reference to panels of a folding door system, but without limitation thereto.

### BACKGROUND ART

A folding door may have several hinged panels, possibly up to eight or even more. These panels are suspended from bogie carriages which run along a track.

A tangential closing action is highly desirable for a door panel as it allows the panel to be located close against a stop or seal, thereby providing better weatherproofing. The door panel normally opens outwards, with a step-up sill on the inside of the door or window sill.

Door and window panels that open with a folding action are traditionally mounted in one of two methods. In the first method, brackets are fixed to the top, bottom or side of the panels of the folding door or window, and the brackets are attached to roller carriers and guides. Adjacent panels are connected together with separate conventional hinges.

The second method uses a combination of a carrier assembly and a flat or strap hinge, which not only suspends a pair of adjacent panels from an overhead track, but also enables the two panels to pivot relative to each other about a vertical hinge axis. The flat or strap hinge has a pair of hinge flaps or leaves which are pivotable about a hinge pin. The hinge pin depends from a carriage adapted to travel along the track. The hinge leaves are screwed or otherwise affixed to the faces of respective adjacent panels. That is, the known carrier/hinge assemblies use flat or strap hinges in which the hinge leaves are face-fixed to a main surface of each panel.

The first method of fixing is susceptible to damage because of the high rotational torque which can be imposed as a panel is opened, particular if there is any out-of-square error in the installation.

The second method requires the hinge leaves to be fixed to the face of the door or window. This is aesthetically unappealing, as the flaps are visually obtrusive. Furthermore, the door is not secure as the fixing screws are easily accessible.

It is an object of this invention to provide an improved combined carrier-and-hinge assembly for track-mounted panels which permits secure and concealed fixing, while still allowing a tangential closing action.

### SUMMARY OF THE INVENTION

In one broad form, the invention provides a combination carrier and hinge assembly for adjacent track-mounted panels, the assembly including

a carriage adapted to travel along a track,

a hinge pin depending from the carriage,

a pair of hinge leaves pivotally connected to the hinge pin to form a butt hinge,

the hinge leaves being adapted to be fixed to respective opposed edge faces of the adjacent panels such that in use, the hinge leaves are located between the edge faces and substantially concealed when the panels are aligned.

For the purpose of this specification, the term “butt hinge” is used to refer to a hinge having a hinge pin or axis, and at least a pair of hinge flaps or leaves which pivot about the hinge pin or axis. The leaves can be folded together, either in abutting relationship, or juxtaposed, or co-planar with one leaf above or within the other. The leaves are adapted to be edge fixed to respective panels.

The butt hinge is preferably of the flush or non-mortise type, with interfitting or interfolding hinge leaves, one within the other.

The hinge pin is preferably threaded into the carriage. The distance between the hinge leaves and the carriage can thereby be varied by rotation of the hinge pin. Since the hinge leaves are fixed to the panels, the height of the panels can be adjusted by rotation of the hinge pin. A locking nut is suitably provided on the hinge pin to fix the hinge pin at the desired height.

In the preferred embodiment, the hinge pin is located at the vertical centroid axis of the carriage. The hinge axis and the pivot axis of the carriage are aligned, thereby eliminating any torque which would otherwise arise from misalignment.

The hinge pin is preferably offset to the plane of each panel. The panels are thereby offset from the track, and can be located close to a step in the surrounding head and sill, to facilitate weatherproofing.

The invention also provides a folding panel system having track-mounted adjacent panels which are connected and suspended by the combination carrier and hinge assembly described above.

In another form, the invention provides a combination hinge and carrier assembly for a pair of adjacent track-mounted panels, the assembly including a butt hinge comprising a hinge pin, and a pair of hinged leaves pivotable about the axis of the hinge pin, the hinge leaves being adapted to be fixed to respective opposed edges of the adjacent panels, and

a carrier comprising a carriage adapted to travel along a track, and a suspension member depending from the carriage and connected to the butt hinge.

In order that the invention may be more fully understood and put into practice, a preferred embodiment thereof will now be described with reference to the accompanying drawings.

### BRIEF DESCRIPTION OF THE DRAWINGS

FIG. 1 is a perspective view of a carrier and guide set utilising a combination carrier/hinge assembly according to one embodiment of this invention.

FIG. 2 is a fragmentary perspective view of a folding door assembly utilising the carrier/hinge assembly of FIG. 1.

FIG. 3 is a fragmentary rear elevation of a folding door utilising the carrier/hinge assembly of FIG.

FIG. 4 is a plan view of part of a folding door utilising the carrier/hinge assembly of FIG. 1.

FIG. 5 is an end elevation of an adjacent door panel having the carrier/hinge assembly and guide set of FIG. 1.

FIG. 6 is a plan view of a folding door utilising the carrier/hinge assembly of FIG. 1.

FIG. 7 is a perspective view of a hinge set suitable for use in a folding door with the carrier and guide set of FIG. 1.

### DESCRIPTION OF PREFERRED EMBODIMENT

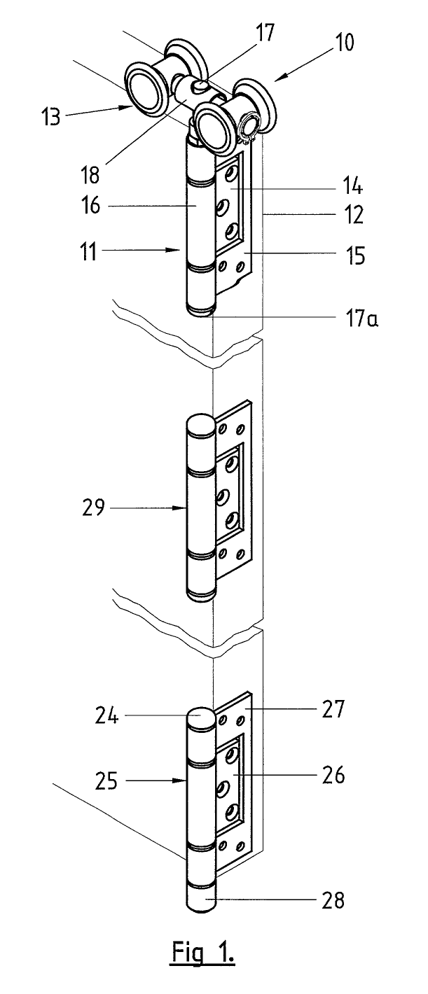

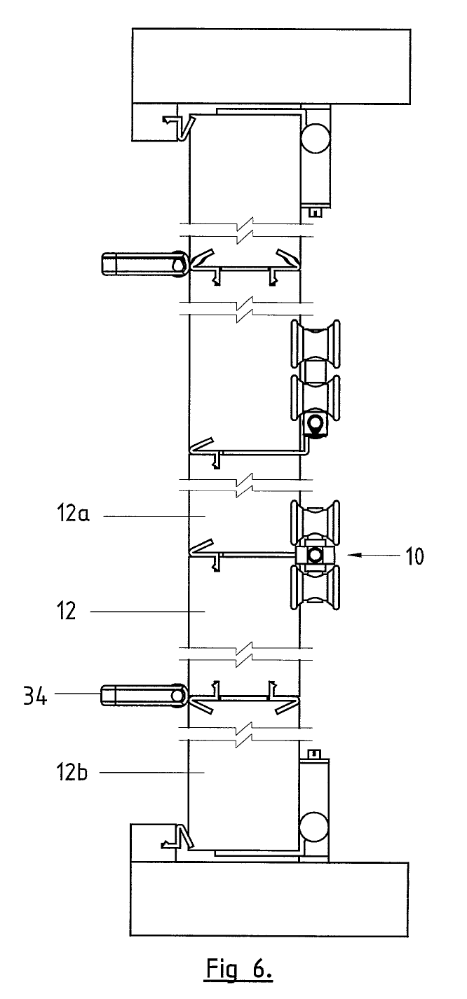

As shown in FIGS. 1-6, a combination carrier/hinge assembly 10 comprises a hinge 11 connected to the edge faces of adjacent panels 12, 12a of a folding door, and a carriage 13 adapted to travel along an overhead track 20. (For clarity, panel 12a has been omitted from FIG. 1, and the overhead track 20 has been omitted from FIGS. 1-4).

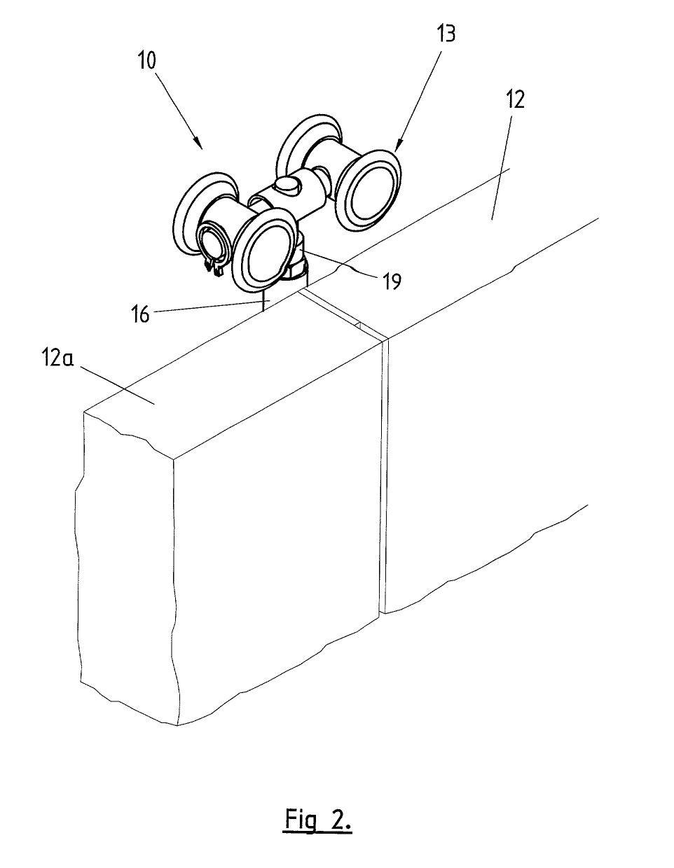

The hinge 11 is a flush or non-mortise hinge with two interfolding or interfitting leaves 14, 15 which are screwed or otherwise affixed to the edges of panels 12, 12a, respectively. By using a non-mortise hinge in which one leaf fits within an opening in the other leaf, the leaves can be aligned in the same plane so that the distance between adjacent panels can be reduced to the thickness of a single hinge leaf, as shown in FIGS. 2-4.

Although a non-mortise hinge is used in the preferred embodiment, it is within the contemplation of this invention to use a butt hinge in which the leaves are fixed in mortises in the edges of the respective adjacent panels.

The leaves 14, 15 are typically each half swaged, and are integrally formed with the knuckle 16 of butt hinge 11. The knuckle 16 defines a tubular cavity in which a hinge pin 17 is located. The hinge pin 17 has a threaded upper end which protrudes above the hinge 11 and is threaded into a nut 18 of the carriage 13. The hinge pin 17 is suitably provided with a screw head 17a or socket head to enable the hinge pin 17 to be screwed into the nut 18.

The carriage 13 is typically in the form of a bogie having two spaced pairs of wheels or rollers. The nut 18 is located on the centroid vertical axis of the bogie carriage 13.

The hinge pin 17 defines not only the hinge axis, but also the pivot axis of the carriage. Hence, the pivot access of the carrier is co-linear with the hinge axis. This eliminates torque loading which might otherwise be generated if the carriage supporting pin is misaligned with the hinge axis.

Screwing the hinge pin 17 into the nut 18 varies the distance between the hinge 11 and the carriage 13. As the hinge 11 is fixed to the panels, and the carriage 13 is mounted on the fixed track 20, it will be evident that the height of the panels can be adjusted by varying the extent to which hinge pin 17 is threaded into nut 18.

A locking nut 19 is provided on the threaded upper end of the hinge pin 17. Once the hinge pin 17 has been screwed into the nut 18 to the desired extent, the nut 19 is tightened against the nut 18 to lock the hinge, and hence the panels, at the desired height.

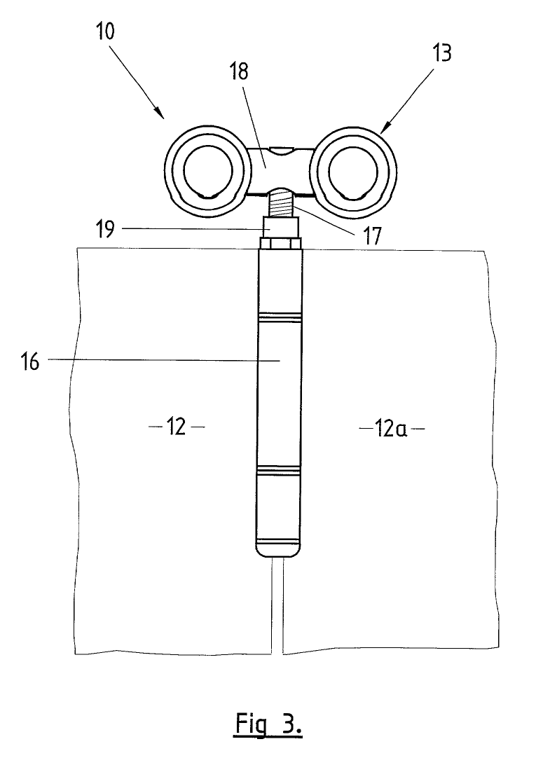

Since the leaves 14, 15 are fixed to the edge faces of the panels 12, 12a, they are concealed when the panels are aligned in the same plane, i.e. closed, as shown in FIG. 3. This creates an aesthetically pleasing appearance, and prevents tampering with the screws which secure the leaves to the panels.

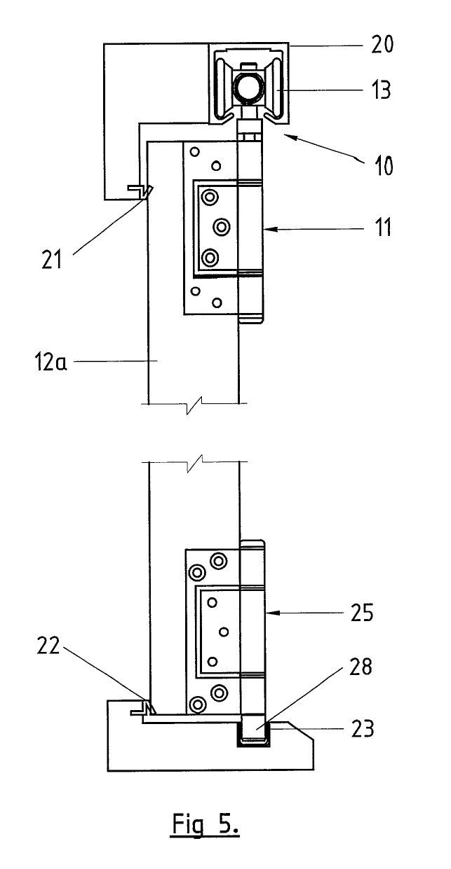

The carrier/hinge assembly 10 is located near the top of the panels 12, 12a and is normally used in conjunction with a guide hinge 25 located near the bottom of the panels, as shown in FIGS. 1 and 5. The guide hinge 25 is also a butt hinge having leaves 26, 27 fixed to the edges of the panels 12, 12a respectively. The guide hinge 25 also has a hinge pin 24 which protrudes below the panels, and locates in a guide channel 23 in the sill of the surrounding frame. The hinge pin is preferably provided with a rotatable bush 28 or other friction reducing means to enable it to slide freely in the guide channel 23.

If appropriate, e.g. for tall panels, one or more intermediate hinges 29 may also be used. Like the top hinge 11, the guide hinge 25 and the intermediate hinge 29 have concealed leaves when the panels are closed.

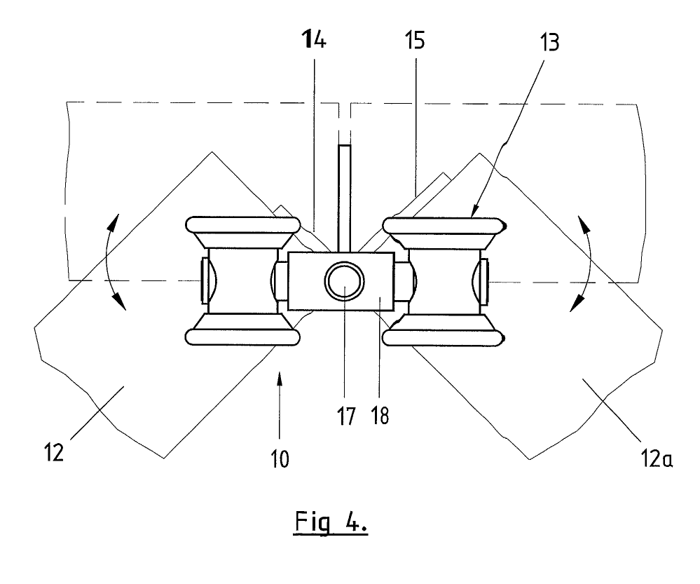

As shown in FIG. 4, the carrier/hinge assembly 10 permits tangential closing of the panels 12, 12a. The offset hinge pin 17 allows the panels to be located close to a step in the head and sill of the door frame as shown in FIG. 5. The small clearance between the panels 12, 12a and the steps in the head and sill of the frame opening are suitably sealed by weather strips 21, 22 thereby weather sealing the folding door. The narrow gap between panels can also be sealed with weatherstrips.

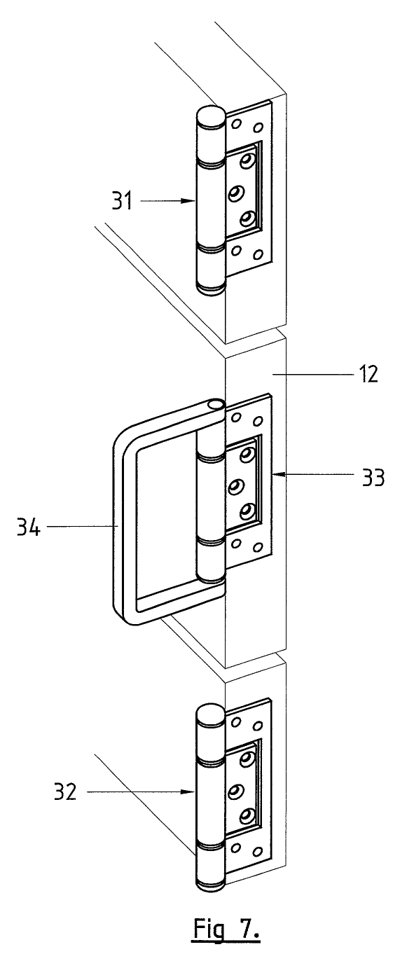

In folding door or window systems having a large number of panels, the carrier and guide set shown in FIG. 1 is between pairs of panels. Adjacent panels of successive pairs, i.e. the panels which fold out of the plane of the door or window, can be hinged together using the hinge set shown in FIG. 7. The hinge set comprises top hinge 31, bottom hinge 32 and intermediate hinge 33. The hinges are non-mortise hinges edge-fixed to adjacent panels, to thereby provide concealed fixing. A folding handle 34 is suitably provided on the hinge pin of middle hinge 33 to enable a user to push the hinge connection out of the plane of the door, and cause the hinged panels to fold together about their common hinges.

The foregoing describes only some embodiments of the invention, and modifications which are obvious to those skilled in art may be made thereto without department from the scope of the invention, as defined in the following claims.

For example, although it is preferred that the hinge 11 is suspended from the carriage 13 by its hinge pin, the hinge 11 can be suspended from the carriage 13 by a suspension member, such as a short rod, connected between a hinged leaf 15 and the carriage 13. This enables the panels to be centred relative to the track.

The claims defining the invention are as follows:

1. A combination carrier and hinge assembly for adjacent track-mounted panels, the assembly including
a carriage adapted to travel along a track,
a hinge pin depending from the carriage,
a pair of hinge leaves pivotally connected to the hinge pin to form a butt hinge,
the hinge leaves being adapted to be fixed to respective opposed edge faces of adjacent panels such that in use, the hinge leaves are located between the edge faces and substantially concealed when the panels are aligned.

2. An assembly as claimed in claim 1, wherein the butt hinge is a non-mortise hinge.

3. An assembly as claimed in claim 1, wherein one of the hinge leaves is positionable within an aperture in the other of the hinge leaves so that the leaves are coplanar when closed.

4. An assembly as claimed in claim 1, wherein the hinge pin is adjustably threaded into the carriage, the distance between the hinge leaves and the carriage being variable by rotation of the hinge pin.

5. An assembly as claimed in claim 4, further comprising a locking nut threaded on the hinge pin.

6. An assembly as claimed in claim 1, wherein the hinge pin is positioned at the vertical centroid axis of the carriage, and is offset relative to the central plane of the panels.

7. A folding panel system having
a track,
a carriage adapted to travel along the track,
at least first and second adjacent panels suspended from the carriage, the panels being moveable longitudinally along the track and pivotable relative to each other about an intermediate vertical axis,
a hinge pin depending from the carriage,
a pair of hinged leaves pivotally connected to the hinge pin to form a butt hinge, the hinge leaves being fixed respectively to opposed edge faces of the first and second panels, whereby in use, the hinge leaves are located between the edge faces and substantially concealed from view when the panels are aligned.

8. A folding panel system as claimed in claim 7, wherein the butt hinge is a non-mortise hinge.

9. A folding panel system as claimed in claim 7, wherein one of the hinge leaves is positionable within an aperture in the other of the hinge leaves so that the leaves are co-planar when closed.

10. A folding panel system as claimed in claim 7, wherein the hinge pin is adjustably threaded into the carriage, the distance between the hinge leaves and the carriage being variable by rotation of the hinge pin.

11. A folding panel system as claimed in claim 7, wherein the hinge pin is positioned at the vertical centroid axis of the carriage, and is offset relative to the central plane of the panels.

12. A folding panel system as claimed in claim 7, further comprising a second butt hinge located near the bottom of the panels, the second butt hinge having a pair of hinge leaves respectively fixed to opposed edge faces of the panels such that the hinge leaves are located between the edge faces and substantially concealed from view when the panels are aligned.

13. A folding panel system as claimed in claim 12, wherein the second butt hinge is a non-mortise hinge.

14. A folding panel system as claimed in claim 12, further comprising a guide channel below the panels, the hinge pin of the second butt hinge extending below the panels and locating in the guide channel.

15. A folding panel system as claimed in claim 7, further comprising
a third panel,
a third butt hinge having a hinge pin and a pair of leaves pivotally connected to the hinge pin, the leaves of the third butt hinge being fixed respectively to opposed edge faces of the second and third panels, and
a handle connected to the hinge pin of the third butt hinge.

16. A folding door system as claimed in claim 15, wherein the third butt hinge is a non-mortise hinge.

17. A combination hinge and carrier assembly for a pair of adjacent track-mounted panels, the assembly including
a butt hinge comprising a hinge pin, and a pair of hinged leaves pivotable about the axis of the hinge pin, the hinge leaves being adapted to be fixed to respective opposed edges of the adjacent panels, and
a carrier comprising a carriage adapted to travel along a track, and a suspension member depending from the carriage and connected to the butt hinge.

18. An assembly as claimed in claim 17, wherein the suspension member is an extension of the hinge pin.

19. As assembly as claimed in claim 17, wherein the suspension member is adjustably threaded into the carriage, whereby the distance between the butt hinge and carriage can be varied by rotation of the suspension member.

20. An assembly as claimed in claim 17, wherein the butt hinge is a non-mortise hinge.
